(19) United States
(12) Patent Application Publication
(10) Pub. No.: US 2008/0188133 A1
(43) Pub. Date: Aug. 7, 2008

(54) Mini card adapter structure

(76) Inventor: Yun-Hsiu Lee, Taipei Hsien (TW)

Correspondence Address: TROXELL LAW OFFICE PLLC, 5205 LEESBURG PIKE, SUITE 1404, FALLS CHURCH, VA, 22041, US

(21) Appl. No.: 11/701,474

(22) Filed: Feb. 2, 2007

(51) Int. Cl. H01R 24/00

(52) U.S. Cl. 439/630

(57) ABSTRACT

The present invention provides a mini card adapter structure that includes an upper cover, a lower cover and a converter terminal set. An insertion slot is defined at a rear portion of the upper cover corresponding to the shape of a micro memory card. A port is designed in a central portion of the lower cover to accommodate a micro memory card. The converter terminal set is configured with eleven terminals, wherein an injection molded fixing mount fixedly covers each terminal, and eleven contact pins extend outward towards a short memory card opening. No. three pin and No. six pin of the eleven contact pins are configured with a large grounding area, and eight extended reverse bent contact pins extend outward toward the micro memory card port. Accordingly, the present invention is able to convert a micro memory card into a short memory card of relatively larger size.

### BACKGROUND OF THE INVENTION

(a) Field of the Invention

The present invention relates to an improved mini card adapter structure, and more particularly to a structural assembly comprising an upper cover, a lower cover and a converter terminal set, which enables converting a micro memory card of relatively small size into a short memory card of relatively larger size to facilitate insertion into digital products having a short memory card circuit interface for use thereof, and provides a configuration having effectiveness to enable the terminals to realize stable contact, reduce costs, effectively control amount of force required for insertion/extraction of the entire connector, reinforce grounding, protect data stored within memory, isolate noise interference, improve memory card data access and increase frequency of use and facilitate design of the card adapter circuit and structure. Moreover, the present invention is applicable for use in various types of card adapter structures or similar structures.

(b) Description of the Prior Art

The current popularity of 3C (computer, communications and consumer electronics) digital products, such as digital cameras, PDAs (personal digital assistants), MP3 (media player) personal stereos, have driven the vigorous development of flash memory cards and the derivation of a variety of memory cards having different size, form and specifications. The current most common memory card specifications include SM (SmartMedia), xD-Picture Card, CF (CompactFlash), MD (MicroDrive), MS (Memory Stick) and SD (Secure Digital), MMC (MultiMedia Card). However, with the increasing miniaturization of 3C digital products, manufacturers have released mini memory cards having substantially smaller size specifications, including the MS and MS PRO extended Duo series, and the extended miniSD, RS-MMC and Transflash derived from the SD and MMC specifications. The Transflash card, however, is still the smallest memory card in the current market, and the MS and MS PRO camps are actively promoting a micro memory card (Memory Stick Micro, M2) similar to that of the Transflash card. Nevertheless, continuous miniaturization of memory cards occupies a small area of the core market, and size of each type of memory card having different structural form and specifications differs or configuration of circuit port contact points varies.

Referring to FIG. 1, which specifies a circuit port of a current micro memory card (Micro SD) a configured with eight contact pins a1 and a circuit port of a short memory card (Mini SD) b configured with eleven contact pins b1, three more than the micro memory card (Micro SD), wherein No. ten and No. eleven contact pins b1 of the short memory card (Mini SD) b are temporarily non-functional, and No. three and No. six contact pins b1 of the short memory card (Mini SD) b are configured with the same function. The form of conventional terminals, as implemented in prior art, are in contrast to direction of card insertion, hence the terminals must be provided with sufficient strength to endure the pushing force of an inserting card. In addition, if evenness of the plurality of terminals in the connector varies, and if a memory card is not kept perpendicular when inserting but inserted at a skewed angle, it is extremely possible that the terminals will be bent and deformed and unable to realize an effective contact. Moreover, in order for the terminals to have sufficient strength to endure the pushing force of an inserting card, in the past terminals made from copper material of at least 0.15 mm thickness were used in a thin memory card adapter, which, after inserting a memory card, resulted in substantially increasing thickness of the entire configuration, and made it difficult to effect stable control of the amount of force required for insertion/extraction of the entire connector. Furthermore, only one grounding pin or a conventional long and thin conducting wire configured between two pins is implemented in prior art, thereby only providing a substantially small grounding area between the two pins, resulting in the long and thin conducting wire easily breaking off or mistakenly touching other pins, causing damage to the circuit and memory structure, and is unable to effectively prevent unexpected signal surges, and thus unable to protect data stored within the memory. In addition, grounding effectiveness of the prior art structure is poor, and is unable to prevent noise interference, moreover, speed of data transmission is unstable, and is unable to improve memory card data access or increase frequency of use. Furthermore, the substantially small grounding area between the two pins inconveniences design of the card adapter circuit and structure. Hence, practical use of the prior art does not meet user requirements.

### SUMMARY OF THE INVENTION

A primary objective of the present invention is to provide a mini card adapter structure that uses a structural assembly of an upper cover, a lower cover and a converter terminal set, wherein eight extended reverse bent contact pins of terminals of the converter terminal set extend outward toward a micro memory card (Micro SD) port, thereby enabling contact direction of each of the terminals to coincide with direction of card insertion, thereby achieving contact effectiveness while preventing the possibility of compressing and damaging the terminals. Moreover, strength requirements of each of the terminals is substantially reduced, enabling terminals to be made from 0.10 mm thick copper material, which, after inserting a memory card, does not result in an substantial increase in thickness of the entire configuration, and enables controlling amount of force required for insertion/extraction to within a substantially small range, thereby better ensuring long term stable usage of the connector, and providing a configuration having effectiveness to enable the terminals to realize stable contact, reduce costs, and effectively control amount of force required for insertion/extraction of the entire connector, which increase practicability and convenience of the entire configuration.

Another objective of the present invention is to provide the mini card adapter structure with a structural configuration wherein a large grounding area is disposed between No. three pin and No. six pin of the converter terminal set to provide the mini card adapter structure with a substantially large and stable grounding area between the two pins, which avoids the shortcomings of prior art whereby the conventional thin conductor easily breaks off or mistakenly touches other pins, resulting in damage to the circuit and memory structure, moreover, is able to effectively prevent unexpected signal surges and protect data stored within the memory, reinforces grounding effectiveness and isolates noise interference, thereby stabilizing speed of data transmission, improving memory card data access and increasing frequency of use. Moreover, the substantially larger and stable grounding area between the two pins facilitates design of the card adapter circuit and structure. Accordingly, providing a configuration having effectiveness to reinforce grounding, protect data stored within memory, isolate noise interference, improve memory card data access and increase frequency of use and facilitate design of the card adapter circuit and structure, which increase practicability, convenience and safety of the entire configuration.

Yet another objective of the present invention is to provide the mini card adapter structure with a structural configuration which enables converting a micro memory card of relatively small size into a short memory card of relatively larger size to facilitate insertion into digital products having a short memory card circuit interface for use thereof, thereby providing convenience of use, and substantially increasing practicability and convenience of the entire configuration.

Yet another objective of the present invention is to provide the mini card adapter structure with a structural configuration wherein the terminals of the converter terminal set supersede contact pins of the conventional circuit board, thereby reducing quality control problems caused by multi-operation assembly, and providing a substantial saving on costs.

In order to achieve the aforementioned objectives, the mini card adapter structure of the present invention comprises an upper cover, a lower cover and a converter terminal set. The upper cover has a structure designed to conform to short memory card (Mini SD) specifications, wherein an insertion slot is defined at a rear portion of the upper cover corresponding to the shape of a micro memory card (Micro SD). The lower cover has a structural disposition corresponding to that of the upper cover, including a port defined in a central portion of the lower cover to accommodate a micro memory card (Micro SD), and the upper cover is correspondingly joined to the lower cover. The converter terminal set is configured with eleven terminals, wherein an injection molded fixing mount fixedly covers each of the terminals of the converter terminal set, and eleven contact pins extend outward towards a short memory card (Mini SD) opening. No. three pin and No. six pin of the eleven contact pins are configured with a large grounding area, and eight extended reverse bent contact pins extend outward toward the micro memory card (Micro SD) port. Accordingly, the present invention is able to convert a micro memory card into a short memory card of relatively larger size to facilitate further use thereof, and provides a configuration having effectiveness to enable the terminals to realize stable contact, reduce costs, effectively control amount of force required for insertion/extraction of the entire connector, reinforce grounding, protect data stored within memory, isolate noise interference, improve memory card data access and increase frequency of use and facilitate design of the card adapter circuit and structure, thereby increasing practicability and convenience of the entire configuration.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a schematic view depicting electrical connections between a micro memory card (Micro SD) and a short memory card (Mini SD) of prior art.

FIG. 2 shows an elevational view of an embodiment of the present invention.

FIG. 3 shows an exploded elevational view of the embodiment depicting component members according to the present invention.

FIG. 4 shows a schematic view of the embodiment depicting folding a large grounding area over and joining a converter terminal set according to the present invention.

FIG. 5 shows a schematic view of the embodiment depicting the grounding area folded over and joining the converter terminal set according to the present invention.

FIG. 6 shows a planar schematic view of the embodiment depicting the grounding area joining the converter terminal set according to the present invention.

FIG. 7 shows a schematic view of the embodiment of the present invention being combined with a micro memory card (Micro SD).

FIG. 8 shows a schematic elevational view of the embodiment of the present invention being combined with a micro memory card (Micro SD).

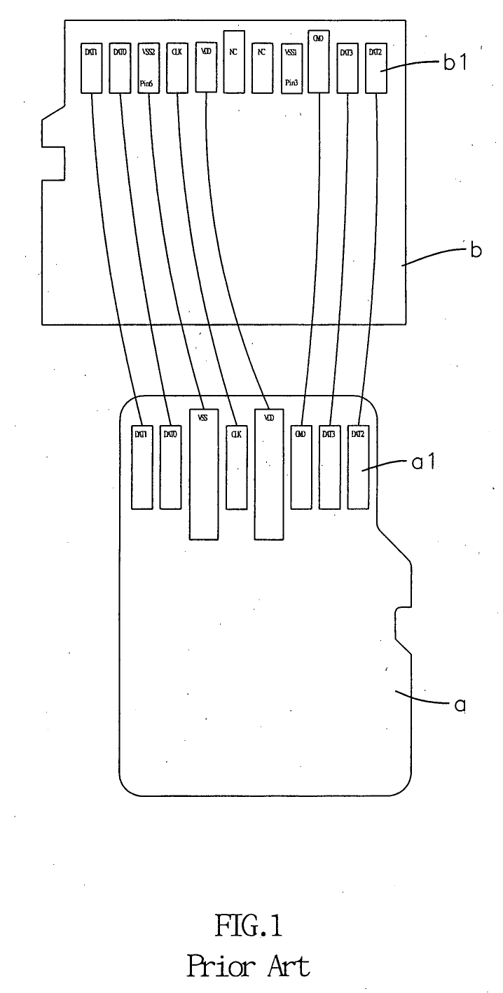

### DETAILED DESCRIPTION OF THE PREFERRED EMBODIMENTS

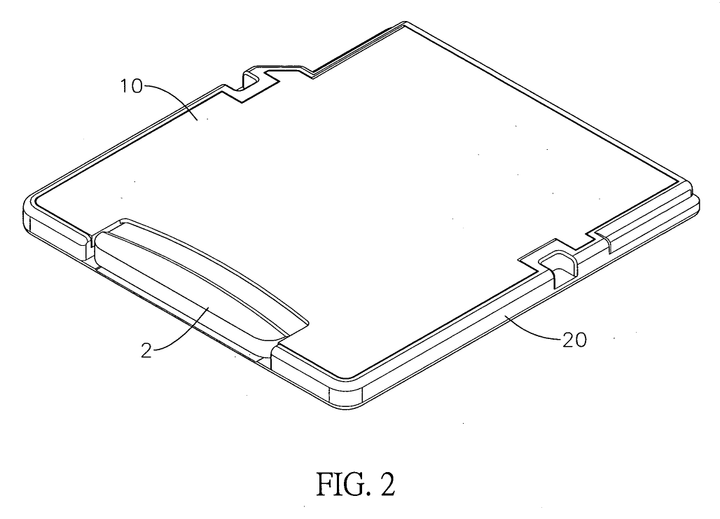

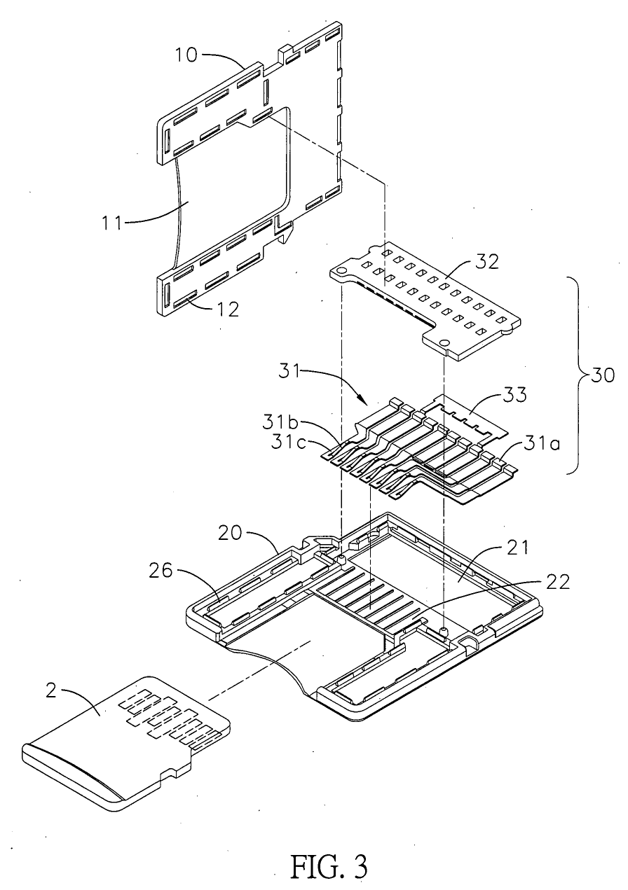

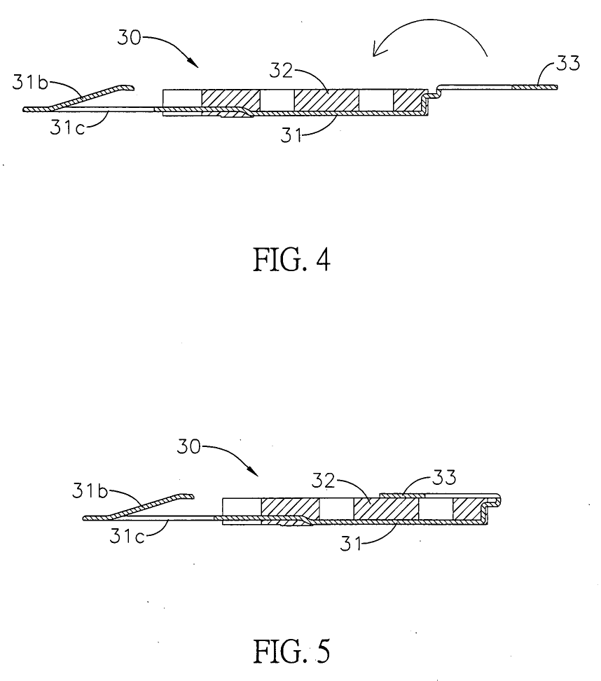

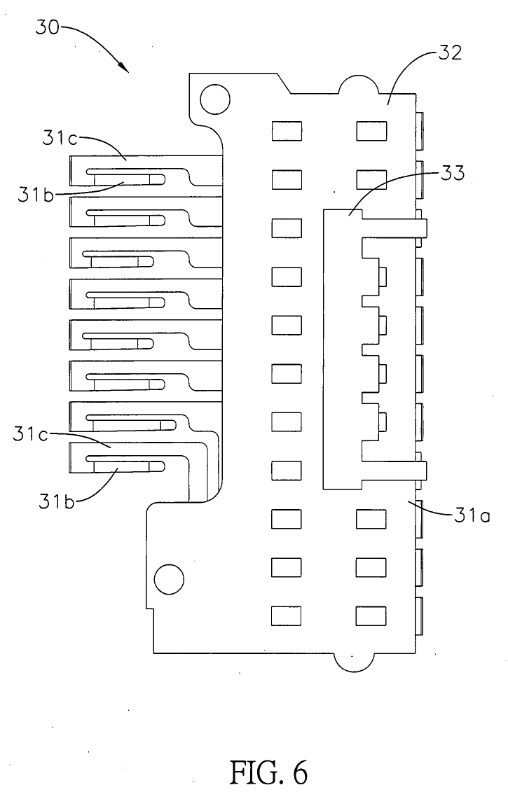

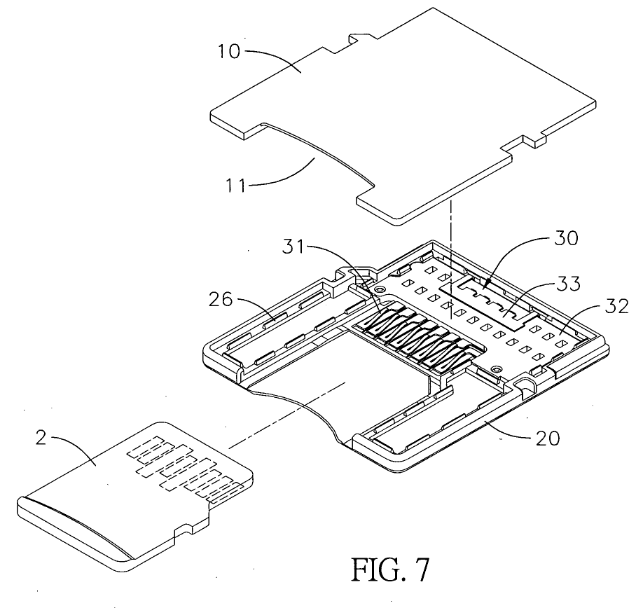

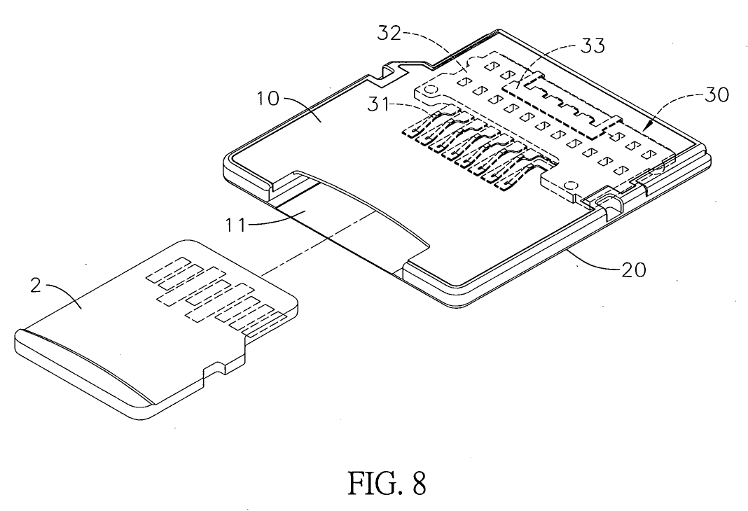

Referring to FIGS. 2˜8, which show an improved mini card adapter structure of the present invention, comprising:

An upper cover 10 having a structure designed to conform to short memory card (Mini SD) specifications, wherein an insertion slot 11 is defined at a rear portion of the upper cover 10 corresponding to the shape of a micro memory card (Micro SD) 2, and a plurality of grooves 12 are defined on a bottom surface of the upper cover 10.

A lower cover 20 having a structure designed to conform to short memory card (Mini SD) specifications, wherein a short memory card (Mini SD) opening 21 is configured at a front portion of the lower cover 20, and a port 22 is defined in a central portion of the lower cover 20 to accommodate a micro memory card (Micro SD). A plurality of protruding pieces 26 are located on the lower cover 20 corresponding to the plurality of grooves 12 of the upper cover, thereby enabling the upper cover 10 to be joined to the lower cover 20 to form a solid structural configuration therewith. Moreover, the upper cover 10 covers and is disposed within the lower cover 20, thereby reducing thickness of the card adapter.

A converter terminal set 30 configured with eleven terminals 31, wherein an injection molded fixing mount 32 fixedly covers each of the terminals 31 of the converter terminal set 30, and eleven contact pins 31a extend outward towards the short memory card (Mini SD) opening 21. No. three pin and No. six pin of the eleven contact pins 31a are configured with a large grounding area 33. An embodiment of the large grounding area 33 of the converter terminal set 30 adopts a bendable large conducting strip (in actual use, method adopted can be a conventional layout of a printed circuit board, conducting coated material or conducting paint), and eight extended reverse bent contact pins 31b extend outward toward the micro memory card (Micro SD) port 22. Each of the eight extended reverse bent contact pins 31b extending outward toward the micro memory card (Micro SD) port 22 is provided with a flat portion 31c, a front end of which is reverse extended and forms an angled bend.

According to the aforementioned structural configuration of the mini card adapter structure of the present invention, as depicted in FIGS. 2˜8, the present invention is characterized in having a structural assembly comprising the upper cover 10, the lower cover 20 and the converter terminal set 30, in which the eight extended reverse bent contact pins 31b of the terminals 31 of the converter terminal set 30 extending outward toward the micro memory card (Micro SD) port 22 are used to enable contact direction of each of the terminals 31 to coincide with direction of card insertion, thereby achieving contact effectiveness while preventing the possibility of compressing and damaging the terminals 31. Moreover, strength requirements of each of the terminals 31 is substantially reduced, and enables controlling amount of force required for insertion/extraction to within a substantially small range, thereby better ensuring long term stable usage of the connector. Furthermore, the large grounding area 33 disposed at the No. three pin and No. six pin of the converter terminal set 30 provides the mini card adapter structure with a substantially large and stable grounding area between the two pins, which avoids the shortcomings of prior art whereby the conventional thin conductor easily breaks off or mistakenly touches other pins, resulting in damage to the circuit and memory structure. Moreover, the present invention is able to effectively prevent unexpected signal surges and protect data stored within the memory. In addition, the mini card adapter structure of the present invention is provided with reinforced grounding effectiveness that isolates noise interference, thereby stabilizing speed of data transmission, improving memory card data access and increasing frequency of use. Moreover, the substantially larger and more stable grounding area between the two pins facilitates design of the card adapter circuit and structure. Accordingly, the present invention provides a configuration having effectiveness to enable the terminals to realize stable contact, reduce costs, effectively control amount of force required for insertion/extraction of the entire connector, reinforce grounding, protect data stored within memory, isolate noise interference, improve memory card data access and increase frequency of use and facilitate design of the card adapter circuit and structure, which increase practicability, convenience and safety of the entire configuration.

According to the aforementioned detailed description, persons familiar with related art are able to easily understand that the present invention can clearly achieve the aforementioned objectives, and evidently complies with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

1-8. (canceled)

9. A mini card adapter structure comprising:
a) an upper cover having an insertion slot located at a rear of the upper cover and having a shape corresponding to a micro memory card;
b) a lower cover connected to the upper cover and having:
i) a short memory card opening located at a front end of the lower cover and having a shape corresponding to a short memory card; and
ii) a micro memory card port located in a central portion of the lower cover and being sized to accommodate the micro memory card; and
c) a converter terminal set having eleven terminals and a fixing mount covering each of the eleven terminals, the eleven terminals having:
i) eleven contact pins located on a first end of the eleven terminals and protruding into the short memory card opening;
ii) eight extended reverse bent contact pins located on a second end of the eleven terminals and extending toward the micro memory card port; and
iii) a grounding area connected to a No. three pin and a No. six pin of the eleven contact pins and covering a predetermined portion of the fixed mount covering, the fixed mount covering is located between the grounding area and the eleven terminals,
wherein each reverse bent contact pin of the eight extended reverse bent contact pins has a flat portion 31c having a first end connected at a side edge thereof to a side edge of the reverse bent contact pin, a second end of each reverse bent contact pin is bent upwardly and has a predetermined length extending in a direction towards the grounding area located on the first end of the eleven terminals.

10. (canceled)

11. The mini card adapter structure according to claim 9, wherein the upper cover is located within the lower cover.

12. The mini card adapter structure according to claim 9, wherein the upper cover has a plurality of grooves located on a bottom surface and the lower cover has a plurality of protruding pieces inserted into the plurality of grooves.

13. The mini card adapter structure according to claim 9, wherein the grounding area is a bendable conducting strip.

14-16. (canceled)
